(19) United States
(12) Patent Application Publication
(10) Pub. No.: US 2021/0190281 A1
(43) Pub. Date: Jun. 24, 2021

(54) AUTOMOBILE LAMP REFLECTIVE LED MODULE SYSTEM AND AUTOMOBILE LAMP ASSEMBLY

(71) Applicant: HASCO VISION TECHNOLOGY CO., LTD., Shanghai (CN)

(72) Inventors: Hui LI, Shanghai (CN); Zhiping QIU, Shanghai (CN); Kaiying GU, Shanghai (CN); Luqing FAN, Shanghai (CN)

(73) Assignee: HASCO VISION TECHNOLOGY CO., LTD., Shanghai (CN)

(21) Appl. No.: 16/757,426

(22) PCT Filed: Sep. 27, 2018
(86) PCT No.: PCT/CN2018/107828

§ 371 Date: Apr. 20, 2020

(30) Foreign Application Priority Data
Dec. 25, 2017 (CN) 201711424943.7
Dec. 25, 2017 (CN) 201721833710.8

(51) Int. Cl. F21S 41/141; F21S 41/32; F21V 17/12; F21V 7/10; F21V 19/00

(52) U.S. Cl. CPC F21S 41/141; F21S 41/32; F21V 17/12; F21Y 2115/10; F21V 19/0035; F21V 19/0055; F21V 7/10

(57) ABSTRACT

The automobile lamp reflective LED module system includes a reflector, at least one circuit board, and at least one radiator, where the reflector has at least one reflection cavity, and at least one LED light source is disposed on the circuit board; the LED light source corresponds to the reflection cavity one to one, and the radiator corresponds to the circuit board one to one; a positioning pin and a mounting hole are disposed on the reflector, a first positioning hole and a first connection hole are disposed on the circuit board, a second positioning hole in fit connection with the positioning pin and a second connection hole in corresponding communication with the first connection hole are disposed on the radiator, and the mounting hole, the first connection hole, and the second connection hole are fixedly connected through a connection member.

### CROSS REFERENCE TO RELATED APPLICATION

This application claims the benefit of priority to Chinese Patent Application No. CN 2017114249437, entitled “Automobile Lamp Reflective Led Module System and Automobile Lamp Assembly”, filed with CNIPA on Dec. 25, 2017, the contents of which are incorporated herein by reference in its entirety.

### BACKGROUND OF THE PRESENT DISCLOSURE

### Field of Disclosure

The present disclosure relates to the field of automobile lamp technology, and in particular, to an automobile lamp reflective LED module system and an automobile lamp assembly comprising thereof.

### Description of Related Arts

Currently, light emitting diodes (LED) are used as light sources of automobile illuminating lamps or signal lights and have taken up a large share in the market of automobile lamps. Reflective LED module systems are widely applied on automobile lamps due to advantages such as a simple principle, high plasticity, and low costs.

In an existing automobile lamp reflective LED module system, a circuit board is a metal substrate, and the radiator is formed by die-cast using aluminum alloy. Therefore, the automobile lamp reflective LED module system is weight and high in cost, which cannot meet the requirement of light weight and low costs for current automobile lamps.

### SUMMARY OF THE PRESENT DISCLOSURE

A technical problem to be solved by the present disclosure is to provide an automobile lamp reflective LED module system that is simple to mount and accurate to position and an automobile lamp assembly comprising the automobile lamp reflective LED module system, to overcome the foregoing defects.

To solve the foregoing technical problem, the following technical solutions are used in the present disclosure:

An automobile lamp reflective LED module system comprises a reflector, at least one circuit board, and at least one radiator, where the reflector has at least one reflection cavity, and at least one LED light source is disposed on the circuit board; the LED light source corresponds to the reflection cavity one to one, a light ray emitted by the LED light source is reflected by the reflection cavity and is emitted, and the radiator corresponds to the circuit board one to one; a positioning pin and a mounting hole are disposed on the reflector, a first positioning hole in fit connection with the positioning pin and a first connection hole in corresponding communication with the mounting hole are disposed on the circuit board, a second positioning hole in fit connection with the positioning pin and a second connection hole in corresponding communication with the first connection hole are disposed on the radiator, and the mounting hole, the first connection hole, and the second connection hole are fixedly connected through a connection member.

Preferably, a plurality of heat dissipation through holes is provided around the LED light source on the circuit board.

Preferably, a metal coating is provided on a wall of the heat dissipation through hole.

Preferably, the heat dissipation through hole is filled with metal material.

Preferably, the radiator is made of aluminum alloy stamping member.

Preferably, black surface treatment is performed to the aluminum alloy stamping member.

Preferably, the circuit board is made of epoxy resin.

Preferably, the reflector is made of plastic, and is formed by one-time injection molding.

Preferably, the connection member is a screw, the mounting hole, the first connection hole, and the second connection hole are all provided with internal threads, and the internal threads are in fit connection with an external thread of the screw.

An automobile lamp assembly comprises the foregoing automobile lamp reflective LED module system.

The present disclosure has a prominent progress:

In the automobile lamp reflective LED module system and the automobile lamp assembly comprising thereof according to the present disclosure, the engaged positioning structures are disposed on the reflector and the circuit board, so that the circuit board is directly positioned on the reflector. Therefore, positioning accuracy of corresponding positions of the LED light source on the circuit board and the reflection cavity of the reflector can be ensured, so that the positioning error is corrected without using other adjustment mechanisms, which means that the corresponding dimming structure is omitted, thereby simplifying a whole structure. Therefore, mounting and assembly are simpler, system stability is better, the weight and cost of the system are reduced.

### BRIEF DESCRIPTION OF THE DRAWINGS

FIG. 1 is a schematic diagram of a separated structure of an automobile lamp reflective LED module system in the prior art.

FIG. 2 is a schematic diagram of mounting and positioning a reflector, a circuit board, and a radiator in an automobile lamp reflective LED module system in the prior art.

FIG. 3 is a schematic diagram of a separated structure of an automobile lamp reflective LED module system according to an embodiment of the present disclosure.

FIG. 4 is a schematic diagram of mounting and positioning a reflector, a circuit board, and a radiator in an automobile lamp reflective LED module system according to an embodiment of the present disclosure.

FIG. 5 is a front view of a circuit board of an automobile lamp reflective LED module system according to an embodiment of the present disclosure.

FIG. 6 is an enlarged view of part A in FIG. 5.

FIG. 7 is a structural diagram of an automobile lamp assembly according to an embodiment of the present disclosure.

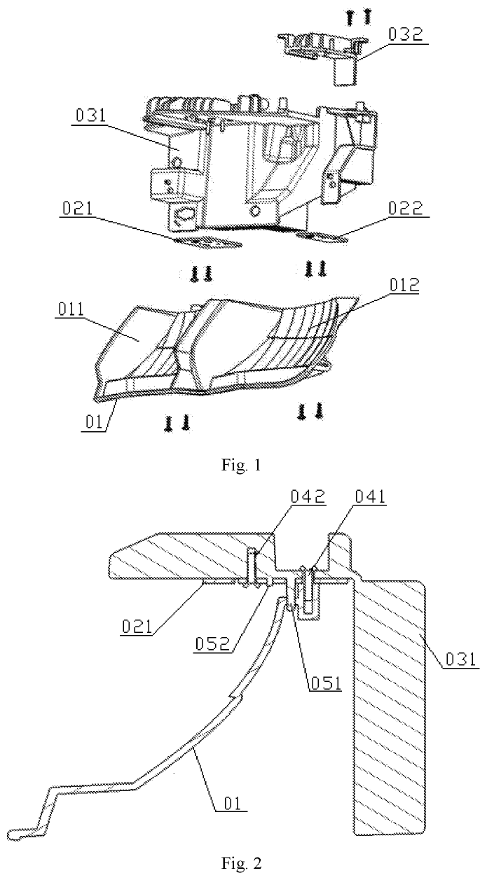

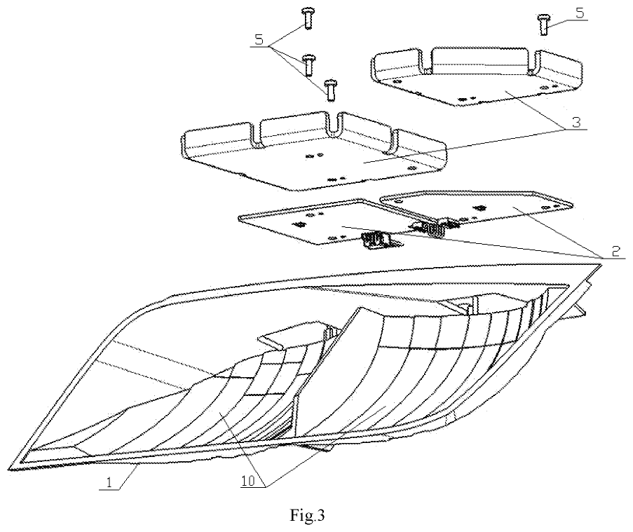

In FIG. 1 and FIG. 2:

| | | |
|---|---|---|
| 01, reflector | 011, first reflection cavity | 012, second reflection cavity |
| 021, first circuit board | 022, second circuit board | 031, first radiator |
| 032, second radiator | 041, first screw | 042, second screw |
| 051, first positioning pin | 052, second positioning pin | |

In FIG. 3 and FIG. 7:

| | | |
|---|---|---|
| 1, reflector | 10, reflection cavity | 11, positioning pin |
| 12, mounting | 2, circuit | 20, heat dissipation through |
| hole | board | hole |
| 21, first positioning hole | 22, first connection hole | 3, radiator |
| 31, second positioning hole | 32, second connection hole | 4, LED light source |
| 5, connection member | 61, first connector | 62, second connector |
| 7, lamp body | 8, external lens | 9, decorative ring |

### DETAILED DESCRIPTION OF THE PREFERRED EMBODIMENTS

Specific implementations of the present disclosure are further described in detail with reference to the accompanying drawings below. These implementations are only used to describe the present disclosure and are not intended to limit the present disclosure. In description of the present disclosure, it should be noted that orientation or position relationships indicated by terms “center”, “longitudinal”, “transverse”, “up”, “down”, “front”, “rear”, “left”, “right”, “vertical”, “horizontal”, “top”, “bottom”, “inside”, “outside”, or the like are orientation or position relationships based on the accompanying drawings, are only for the purpose of describing the present disclosure and simplifying the description, do not indicate or imply that indicated apparatuses or components necessarily have particular orientations or are necessarily constructed and operated at particular orientations, and therefore should not be construed as a limitation to the present disclosure. In addition, terms “first” and “second” are merely for the purpose of description and cannot be construed as indicating or implying relative importance.

In the description of the present disclosure, it should be noted that unless otherwise explicitly specified or defined, the terms such as “mount”, “connect”, and “connection” should be understood in a broad sense. For example, the connection may be a fixed connection, a detachable connection, or an integral connection; or the connection may be a mechanical connection or an electrical connection; or the connection may be a direct connection, an indirect connection through an intermediary, or internal communication between two components. A person of ordinary skill in the art could understand specific meanings of the terms in the present disclosure according to specific situations.

In addition, in the description of the present disclosure, unless otherwise stated, “a plurality of” means two or more.

The automobile lamp reflective LED module system usually uses a multi-cavity reflector, having a plurality of reflection cavities, each of the reflection cavities is correspondingly provided with a circuit board loaded with an LED light source and a radiator for dissipating heat of the circuit board. Taking a reflector having two reflection cavities as an example, as shown in FIG. 1, a reflector 01 comprises a first reflection cavity 011 and a second reflection cavity 012, a first circuit board 021 corresponds to the first reflection cavity 011, and a second circuit board 022 corresponds to the second reflection cavity 012, LED light sources are disposed on both the first circuit board 021 and the second circuit board 022, and light rays emitted by the LED light sources are reflected by the corresponding reflection cavities and are emitted, to generate needed light type. A first radiator 031 is configured to dissipate heat of the first circuit board 021, and a second radiator 032 is configured to dissipate heat of the second circuit board 022. The corresponding parts are connected by using screws. As shown in FIG. 2, during assembly, the reflector 01 is positioned on the first radiator 031 through a first positioning pin 051 on the first radiator 031, and then the reflector 01 is mounted on the first radiator 031 through a first screw 041; the first circuit board 021 is positioned on the first radiator 031 through a second positioning pin 052 on the first radiator 031, and then the first circuit board 021 is fixedly mounted on the first radiator 031 through a second screw 042. The second circuit board 022 is positioned on the second radiator 032 through a positioning pin on the second radiator 032, then the second circuit board 022 is fixedly mounted on the second radiator 032 through a screw, and then the second radiator 032 is fixedly mounted on the first radiator 031 through a screw. Thus, assembly is completed, and the assembled components are mounted in an automobile lamp.

In the foregoing assembling, the radiator is used as a core positioning member, and indirect positioning is provided between the circuit board and the reflector, which may easily result in insufficient positioning accuracy of corresponding positions of the LED light source on the circuit board and the reflection cavity of the reflector. Therefore, after the second circuit board 022 is fixedly mounted on the second radiator 032, the second radiator 032 is fixedly mounted on the first radiator 031 only after a positioning error is corrected by adjusting positions first, and effect of the positioning error is eliminated through relative dimming between LED light sources corresponding to the multi-cavity reflector, to ensure that the output light type meets requirements. Therefore, this assembling is complex in structure and poor in reliability.

As shown in FIGS. 3 to 6, an embodiment of an automobile lamp reflective LED module system according to the present disclosure is provided. The automobile lamp reflective LED module system in this embodiment comprises a reflector 1, at least one circuit board 2, and at least one radiator 3. The reflector 1 has at least one reflection cavity 10, the circuit board 2 is provided with at least one LED light source 4. The LED light sources 4 each corresponds to one of the reflection cavities 10 of the reflector 1, that is, each reflection cavity 10 of the reflector 1 corresponds to a LED light source 4. In other words, the number of the LED light sources 4 is the same as the number of the reflection cavities 10 of the reflector 1 Light ray emitted by each LED light source 4 is reflected by the corresponding reflection cavity 10 and then is emitted, so as to form a required illumination light type. All LED light sources 4 may be disposed on the same circuit board 2. Therefore, only one circuit board 2 is needed. Alternatively, only one LED light source 4 may be provided on a circuit board 2, in this case, the number of the circuit boards 2 needs to be the same as the number of the reflection cavities 10 of the reflector 1, and adjacent circuit boards 2 are electrically connected through a first connector 61 (referring to FIG. 5). The radiator 3 corresponds to the circuit board 2. That is, each circuit board 2 is correspondingly provided with a radiator 3. In other words, the number of the radiators 3 is the same as the number of the circuit boards 2, and each radiator 3 is configured to dissipate heat of the corresponding circuit board 2.

The number of the reflection cavities 10 of the reflector 1 in this embodiment is not restricted, the number of the LED light sources 4 depends on the number of the reflection cavities 10 of the reflector 1, the number of the circuit boards 2 depends on the number and setting manner of the LED light sources 4, and the number of the radiators 3 depends on the number of the circuit boards 2. For example, as shown in FIG. 3, the reflector 1 may be provided with two reflection cavities 10. Each reflection cavity 10 may be correspondingly provided with a circuit board 2. Therefore, each circuit board 2 is provided with an LED light source 4, and each circuit board 2 is correspondingly provided with a radiator 3.

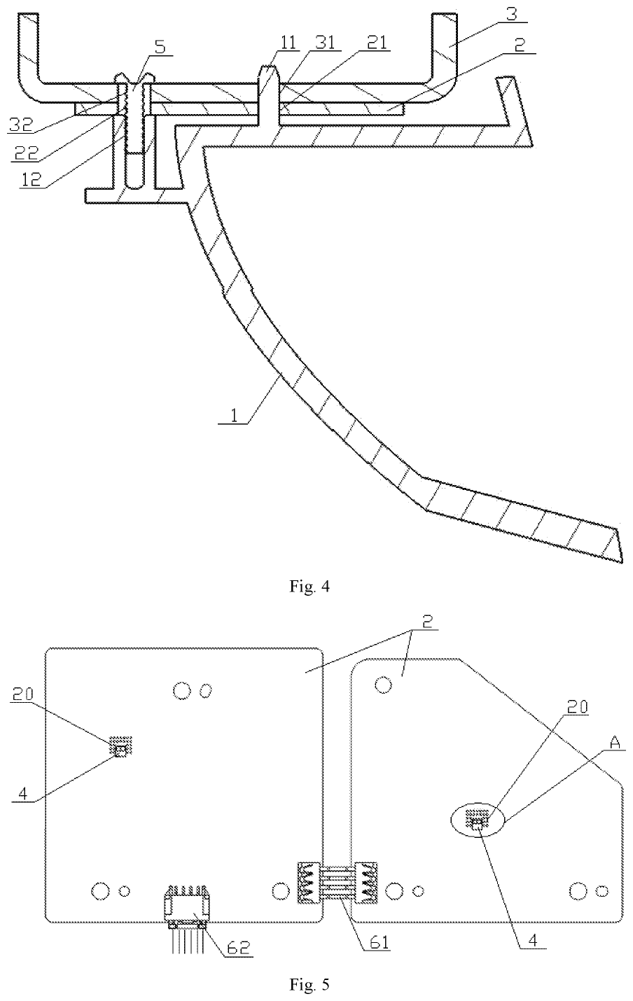

As shown in FIG. 4, in this embodiment, the reflector 1 is provides with a positioning pin 11 and a mounting hole 12. The numbers of the positioning pins 11 and the mounting holes 12 are not less than the number of the circuit boards 2. That is, each circuit board 2 corresponds to at least one positioning pin 11 and at least one mounting hole 12. A first positioning hole 21 and a first connection hole 22 are disposed on the circuit board 2, and the first positioning hole 21 and the first connection hole 22 are both through holes. The first positioning hole 21 is in fit connection with the corresponding positioning pin 11 on the reflector 1, to position the circuit board 2 on the reflector 1. The first connection hole 22 is in corresponding communication with the corresponding mounting hole 12 on the reflector 1. A second positioning hole 31 and a second connection hole 32 are disposed on the radiator 3, and the second positioning hole 31 and the second connection hole 32 are both through holes. The second positioning hole 31 is in fit connection with the corresponding positioning pin 11 on the reflector 1, to position the radiator 3 on the reflector 1. The second connection hole 32 is in corresponding communication with the corresponding first connection hole 22 on the circuit board 2.

During assembly, the circuit board 2 may be positioned on the reflector 1 through fitting connection between the first positioning hole 21 on the circuit board 2 and the positioning pin 11 on the reflector 1, so as to implement direct positioning between the circuit board 2 and the reflector 1, then the radiator 3 is attached to the circuit board 2 and is positioned on the reflector 1 through fitting connection between the second positioning hole 31 on the radiator 3 and the positioning pin 11 on the reflector 1. After positioning, the mounting hole 12 on the reflector 1, the first connection hole 22 on the circuit board 2, and the second connection hole 32 on the radiator 3 are in corresponding communication with each other and may be fixedly connected through a connection member 5, to implement fixed connection among the reflector 1, the circuit board 2, and the radiator 3. Preferably, the connection member 5 may be a screw, the mounting hole 12 on the reflector 1, the first connection hole 22 on the circuit board 2, and the second connection hole 32 on the radiator 3 are all provided with internal threads, and the external thread of the screw is in fitting connection with the internal threads of the mounting hole 12 on the reflector 1, the first connection hole 22 on the circuit board 2, and the second connection hole 32 of the radiator 3 in sequence.

Therefore, in the automobile lamp reflective LED module system in this embodiment, the engaged positioning structures are disposed on the reflector 1 and the circuit board 2, so that the circuit board 2 is directly positioned on the reflector 1. Therefore, positioning accuracy of corresponding positions of the LED light source 4 on the circuit board 2 and the reflection cavity 10 of the reflector 1 can be ensured, so that the positioning error is corrected without using other adjustment mechanisms, which means that a corresponding dimming structure can be omitted, thereby simplifying the whole structure. Therefore, mounting and assembly are simpler, system stability is better, the weight and cost of the system are reduced.

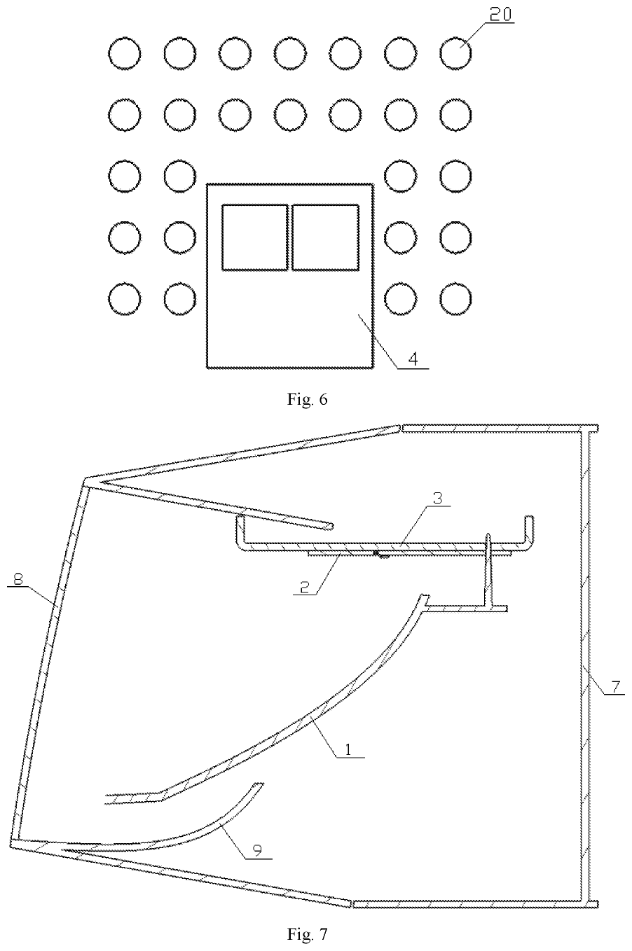

Preferably, in this embodiment, the circuit board 2 is an FR4 circuit board. The material of the circuit board 2 may be epoxy resin. Compared with common metallic circuit board, epoxy resin is light and low cost. Further, as shown in FIG. 5 and FIG. 6, a plurality of heat dissipation through holes 20 may be provided around the LED light source 4 on the circuit board 2, so as to improve heat dissipation performance of the circuit board 2 and help the LED light sources 4 and other electronic devices on the circuit board 2 dissipate heat. In order to enhance a heat dissipation effect, a metal coating, such as a copper plated layer or a nickel plated layer, may be provided on the wall of the heat dissipation through hole 20, or a metal material, such as copper or nickel, may be filled in the heat dissipation through hole 20. The sizes, the number, and distribution positions of the heat dissipation through holes 20 are not limited and may be adjusted and arranged according to different thermal calculation results. In addition, a second connector 62 configured to connect the automobile lamp reflective LED module system in this embodiment to an automobile body bundle is further disposed on the circuit board 2.

Preferably, in this embodiment, the radiator 3 may be made of aluminum alloy stamping member, and more preferably, made of aluminum alloy stamping sheet metal member. Compared with common aluminum alloy die casting member, the aluminum alloy stamping sheet metal member is fast in molding, light in weight, and low in cost. Further, black surface treatment is performed to the aluminum alloy stamping member. Compared with surface treatment of other colors, black surface treatment has stronger surface thermal radiation capability, and can transfer system heat to the environment more efficiently.

Preferably, in this embodiment, the material of the reflector 1 may be plastics, and the reflector 1 having a plurality of reflection cavities 10 may be formed by one-time injection molding, so that accuracy between the plurality of reflection cavities 10 can be ensured.

The automobile lamp reflective LED module system in this embodiment may be used in automobile illuminating lamps or signal lights.

Based on the foregoing automobile lamp reflective LED module system, this embodiment further provides an automobile lamp assembly. As shown in FIG. 7, the automobile lamp assembly in this embodiment comprises the foregoing automobile lamp reflective LED module system, and may further comprise a lamp body 7, an external lens 8, and a decorative ring 9. The reflector 1, the circuit board 2, and the radiator 3 are disposed inside the lamp body 7, and the external lens 8 is disposed at the front of a light emergent direction of the automobile lamp reflective LED module system.

In conclusion, in the automobile lamp reflective LED module system and the automobile lamp assembly according to this embodiment, the engaged positioning structures are disposed on the reflector 1 and the circuit board 2, so that the circuit board 2 is directly positioned on the reflector 1. Therefore, positioning accuracy of corresponding positions of the LED light source 4 on the circuit board 2 and the reflection cavity 10 of the reflector 1 can be ensured, so that the positioning error is corrected without using other adjustment mechanisms, which means that the corresponding dimming structure is omitted, thereby simplifying a whole structure. Therefore, mounting and assembly is simpler, system stability is better, the weight and cost of the system are reduced. In addition, a plurality of heat dissipation through holes 20 is provided around the LED light source 4 on the circuit board 2, a metal coating is provided on the wall of the heat dissipation through hole 20, or a metal material is filled in the heat dissipation through hole 20, to effectively improve heat dissipation performance of the circuit board 2 and help the LED light sources 4 and other electronic devices on the circuit board 2 dissipate heat. Moreover, the common metal circuit board is replaced by the epoxy resin FR4 circuit board, and the material of the radiator 3 is aluminum alloy stamping member instead of the common aluminum alloy die casting member. The epoxy resin FR4 circuit board and the aluminum alloy stamping member both are light in weight and low in cost, so as to greatly reduce the whole weight of the system and reduce system costs.

Preferred implementations of the present disclosure are described above. It should be noted that a person of ordinary skill in the art may make various improvements and replacements without departing from the technical principle of the present disclosure, and these improvements and replacements should also be regarded as the protection scope of the present disclosure.

1. An automobile lamp reflective LED module system, comprising a reflector (1), at least one circuit board (2), and at least one radiator (3), wherein the reflector (1) has at least one reflection cavity (10), and at least one LED light source (4) is disposed on the circuit board (2); the LED light source (4) corresponds to the reflection cavity (10) one to one, a light ray emitted by the LED light source (4) is emitted after being reflected by the reflection cavity (10), and the radiator (3) corresponds to the circuit board (2) one to one; a positioning pin (11) and a mounting hole (12) are disposed on the reflector (1), a first positioning hole (21) in fit connection with the positioning pin (11) and a first connection hole (22) in corresponding communication with the mounting hole (12) are disposed on the circuit board (2), a second positioning hole (31) in fit connection with the positioning pin (11) and a second connection hole (32) in corresponding communication with the first connection hole (22) are disposed on the radiator (3), and the mounting hole (12), the first connection hole (22), and the second connection hole (32) are fixedly connected through a connection member (5).

2. The automobile lamp reflective LED module system according to claim 1, wherein a plurality of heat dissipation through holes (20) is provided around the LED light source (4) on the circuit board (2).

3. The automobile lamp reflective LED module system according to claim 2, wherein a metal coating is provided on a wall of the heat dissipation through hole (20).

4. The automobile lamp reflective LED module system according to claim 2, wherein the heat dissipation through hole (20) is filled with metal material.

5. The automobile lamp reflective LED module system according to claim 1, wherein the radiator (3) is made of aluminum alloy stamping member.

6. The automobile lamp reflective LED module system according to claim 5, wherein black surface treatment is performed to the aluminum alloy stamping member.

7. The automobile lamp reflective LED module system according to claim 1, wherein the circuit board (2) is made of epoxy resin.

8. The automobile lamp reflective LED module system according to claim 1, wherein the reflector (1) is made of plastic, and is formed by one-time injection molding.

9. The automobile lamp reflective LED module system according to claim 1, wherein the connection member (5) is a screw, the mounting hole (12), the first connection hole (22), and the second connection hole (32) are all provided with internal threads, which are in fit connection with an external thread of the screw.

10. An automobile lamp assembly, comprising the automobile lamp reflective LED module system according to claim 1.
